(19) United States
(12) Patent Application Publication
(10) Pub. No.: US 2005/0139534 A1
(43) Pub. Date: Jun. 30, 2005

(54) Ribbed plastic tray insert apparatus and method for supporting filter media in an engine or transmission filter

(76) Inventors: C. Alan Peet, Waterman, IL (US); Abe Khalil, Barrington, IL (US); James Wolford, Chicago, IL (US)

Correspondence Address: BAKER & HOSTETLER LLP;Washington Square, Suite 1100, 1050 Connecticut Avenue, N.W., WASHINGTON, DC, 20036, US

(21) Appl. No.: 10/747,164

(22) Filed: Dec. 30, 2003

(51) Int. Cl. B01D 29/00

(52) U.S. Cl. 210/168; 210/171; 210/483

(57) ABSTRACT

A tray insert for supporting filter media in an engine or transmission oil filter. The tray insert is preferably made from plastic and can preferably rest on the bottom of the filter housing. Alternatively, the tray insert can preferably be made of plastic or metal and rests on at least the lip portion of the filter housing.

### FIELD OF THE INVENTION

The present invention relates generally to engine or transmission oil filters. More particularly, the present invention relates to tray inserts for supporting filter media in engine or transmission oil filters, preferably metal or composite engine or transmission oil filters.

### BACKGROUND OF THE INVENTION

Engine and transmission oil filters can include a housing encompassing a filter medium. The housing typically has a top half (or upper cover) and a lower half (or lower cover) and can be all metal, all plastic, or can be composite in construction (metal and plastic). In filters having clean fluid both above and below the filter medium (for example, in filters having media in a bag configuration), the filter media is preferably kept off the bottom of the lower cover and off the top of the upper cover so that clean fluid can flow to the filter outlet unobstructed by the filter bag medium.

In the case of metal and composite filters, flow ribs stamped (drawn) into the metal lower tray are used to keep the filter medium from touching the bottom of the lower cover and blocking fluid flow. This design can have drawbacks. First, the ribs themselves block fluid flow space and can create bottleneck regions in the fluid flow path. Second, in order to provide structural support to alleviate the effects of suction on the oil filter housing, pinch points are built into the oil filters, where a depression in the upper cover presses against a rib in the lower cover. These pinch points compress the filter bag medium, obstructing fluid flow.

All-plastic oil filters, on the other hand, have the drawback that the top half of the housing and bottom half of the housing cannot be crimped together without the use of an additional binding ring or utilization of processes having assembly rates slower than crimping. Therefore, expensive welding processes are used to seal the covers together. In addition, certain welding processes such as vibration welding introduce higher levels of contaminant into the filters. Filter media fibers can dislodge due to the friction of the vibration welding process and contaminate the filter. As well, all-plastic oil filters require a greater wall thickness to achieve comparable strength and stiffness to a composite filter and consequently many customers demand composite oil filters.

Engine or transmission filters also typically include inlet tubes. These tubes can be made from metal or they can be made from plastic. Metal inlet tubes are typically formed as a separate component because metal cannot be drawn from the lower cover to the depth or shape that is often needed for the inlet tubes. Utilizing a separate component adds cost to the filter. Further, because separate metal tubes are attached by crimping, the cross-sectional geometry of the metal tubes is limited, and angled or shaped tubes are difficult to implement. Specifically, metal inlet tubes are limited to having a round or oval cross-sectional geometry because it is difficult to crimp other metal shapes. Use of angled or shaped inlets can introduce error in the manufacturing process because an operator must insure that the inlet tube is properly oriented rotationally prior to crimping. While all-plastic tubes can be integrally formed when used with all-plastic filters thereby alleviating the problem of limited cross-sectional geometry and angle, as mentioned above, all-plastic filters can have the problem of contamination and/or expense.

Accordingly, it is desirable to provide an oil filter method and apparatus that alleviates the fluid flow problems caused by use of lower metal covers having stamped flow ribs. It is also desirable to provide an oil filter method that can utilize the thin walls provided by metal covers. It is also desirable to provide an oil filter method and apparatus that alleviates the fluid flow problems caused by pinch points closing the media (as in a bag filter). It is also desirable to provide an oil filter method and apparatus that includes an inlet tube which can be both cost-efficient and has desirable design flexibility.

### SUMMARY OF THE INVENTION

The foregoing needs are met, to a great extent, by the present invention, wherein in one aspect an apparatus is provided that in some embodiments provides a tray insert for an engine or transmission filter for supporting the filter media off the bottom of the lower cover.

In accordance with one embodiment a filter for engines or transmissions is provided having a filter housing encompassing a plastic tray insert for supporting a filter media (usually in bag configuration) off the bottom of the filter housing. The tray insert is configured to rest on the filter housing, which includes an upper cover and a lower cover. In some embodiments, the tray insert rests on the bottom of the lower cover of the filter housing. In some embodiments, the tray insert rests on a lip portion of the lower cover of the filter housing and is suspended above the bottom cover of the filter housing. In some embodiments, the suspended tray insert also includes legs extending downward toward the bottom of the lower cover of the filter housing. In some embodiments, the plastic tray insert can include integral pass-through pinch points. In some embodiments, the plastic tray insert can include an integral plastic inlet opening which may be configured with an anti-drainback device.

In accordance with another embodiment, a filter for engines or transmissions is provided having a filter housing, including an upper cover and a lower cover and encompassing a metal tray insert for supporting filter media off the bottom of the filter housing. In some embodiments, the tray insert is configured to rest on a lip portion of the lower cover of the filter housing and is suspended above the bottom cover of the filter housing. In some embodiments, the suspended tray insert also includes legs extending downward toward the bottom of the lower cover of the filter housing.

In accordance with another embodiment of the present invention, a metal or composite engine or transmission filter is provided which includes filtering means, means for housing said filtering means wherein the means for housing includes a lower cover, means for suspending the filtering means within said means for housing wherein the means for suspending is not integral with the upper or lower cover.

In accordance with yet another embodiment of the present invention, a method for alleviating fluid flow problems associated with filters having ribs stamped into the lower cover is provided. The method includes providing a tray insert for use with a metal or composite oil filter. In some embodiments, the method also includes positioning the tray insert in the lower cover of an oil filter, positioning the filter media on the tray insert, and positioning an upper cover above the filter media and lower cover.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a top perspective view illustrating a tray insert according to a preferred embodiment of the invention resting on the bottom of the lower cover of an engine or transmission filter.

FIG. 2 is a top view of a tray insert according to another preferred embodiment of the invention resting on the bottom of the lower cover of an engine or transmission filter.

FIG. 3 is a detail cross-sectional view of a plastic pinch point suitable for use with plastic tray inserts according to the present invention.

FIG. 4 is a detail cross-sectional view of a pinch point in accordance the prior art.

FIG. 5 is a detail cross-sectional view of an inlet opening suitable for use with plastic tray inserts according to the present invention.

FIG. 6 is a perspective view of another tray insert in accordance with the present invention.

FIG. 7 is an exploded view of an oil filter made with the tray insert of FIG. 6.

FIG. 8 is a cross-sectional view of a suspended tray insert design in accordance with another embodiment of the present invention.

FIG. 9 is a perspective view of the tray insert of FIG. 8.

FIG. 10 is a perspective view of a suspended tray insert design in accordance with another embodiment of the present invention.

FIG. 11 is a cross-sectional view of a suspended tray insert design in accordance with another embodiment of the present invention.

FIG. 12 illustrates the profile of a stamped (drawn) metal rib versus the profile of an exemplary plastic rib in accordance with an embodiment of the present invention.

FIG. 13 is a side view of a metal filter configured with a plastic tray insert having an integral plastic inlet tube in accordance with an embodiment of the invention.

FIG. 14 is a cutaway perspective view of the filter of FIG. 13.

### DETAILED DESCRIPTION

The invention will now be described with reference to the drawing figures, in which like reference numerals refer to like parts throughout. A metal or composite engine or transmission filter can comprise a two-part housing having a lower cover and an upper cover encompassing filter media (these embodiments show the media in a bag configuration). The housing covers are either both metal, or in the case of a composite filter, one cover can be plastic, while the other cover is made from metal. According to the prior art, to support the filter bag above the bottom of the lower cover, yet still permitting fluid flow along the bottom portion of the lower cover, the lower metal cover is stamped with a series of spaced-apart ribs protruding into the interior of the filter housing. The ribs support the filter bag above the bottom of the lower cover, and the space between the ribs provides regions for fluid flow.

The present invention provides a tray insert which can take the place of stamped metal ribs, and thus can be used with metal covers which do not have stamped metal ribs. The tray insert is adapted to rest within the filter housing such that the filter bag is supported away from the housing by the tray insert.

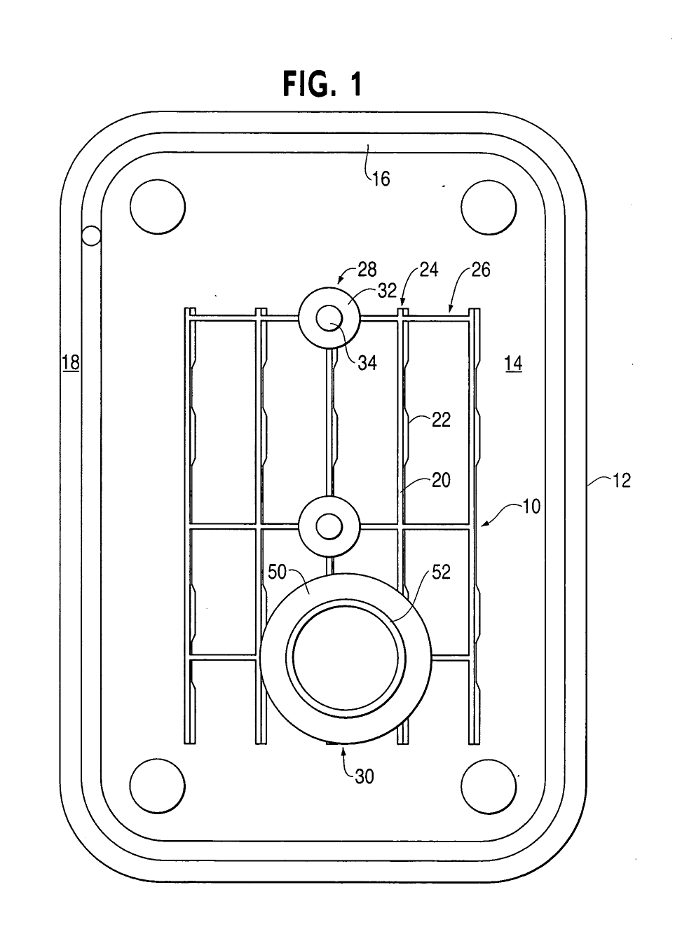

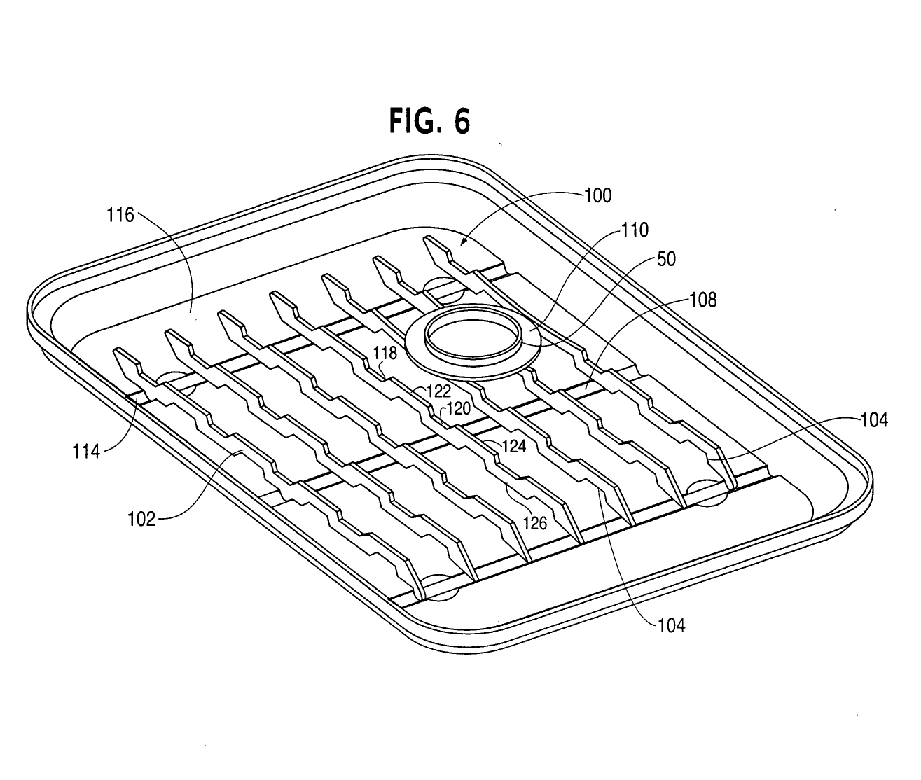

According to some embodiments of the invention, the tray insert is made of plastic, and is typically injection molded as a single integral piece. According to some embodiments of the present invention, the tray insert is a plastic rib-tray insert, which rests on the bottom of the lower housing (which preferably is not itself stamped with ribs). FIGS. 1 and 6 illustrate exemplary plastic rib-tray inserts in accordance with the present invention.

In the embodiment of FIG. 1, the rib-tray insert comprises a set of interlinked linear segments supported by ribs. According to this embodiment, the top face of the interlinked linear segments provides a surface for supporting the filter media, this surface is spaced apart from the bottom of the lower cover by the ribs.

In the embodiment of FIG. 6, the tray comprises a set of interlinked plastic ribs. According to this embodiment, the top face of the ribs provides a surface for supporting the filter above the bottom of the lower cover, whereas the bottom surface of the ribs rests on the bottom of the lower cover.

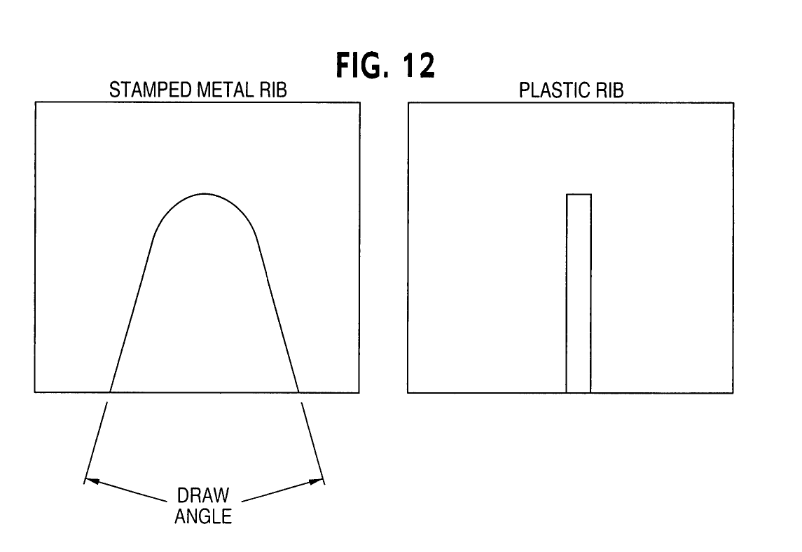

An advantage of a plastic rib-tray insert, as compared to a metal lower cover having stamped metal ribs, is that plastic ribs can be made with a much higher aspect ratio (i.e. the height of the rib versus the width of the rib) than stamped (drawn) metal ribs. Therefore, as compared to stamped metal ribs, plastic ribs can block less fluid flow. FIG. 12 compares the profile of a stamped metal rib versus an exemplary plastic rib illustrating that there can be less blocked flow space associated with plastic ribs suitable for use with plastic tray inserts according to the present invention.

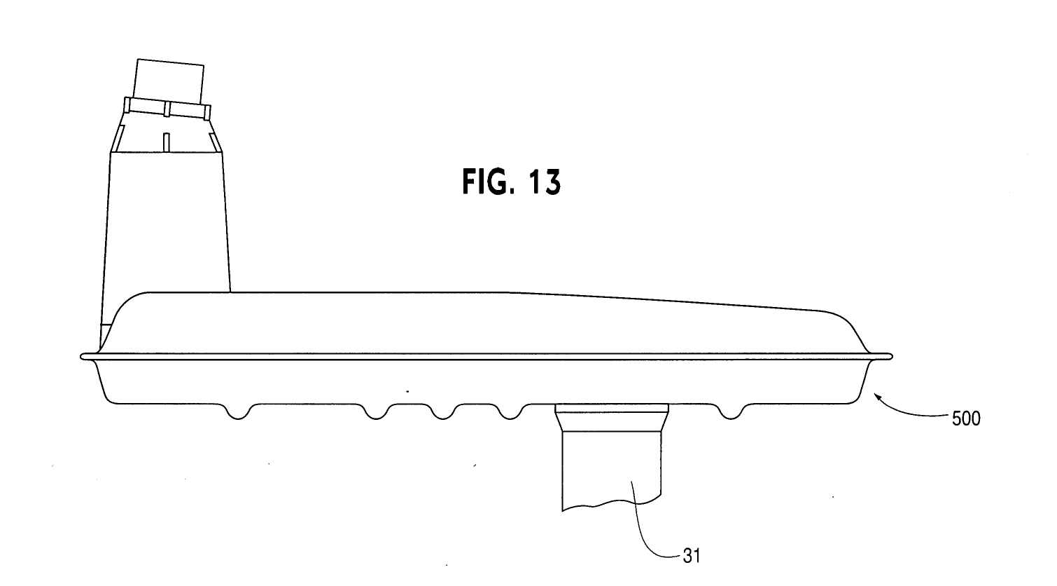

Another advantage of using a plastic tray insert over stamping ribs into the lower cover can be that the plastic insert can include an integral plastic inlet tube. Use of a plastic inlet tube provides design flexibility as compared to a separate metal inlet tube. For example, a plastic inlet tube can have cross-sectional geometries other than oval or round shapes. In addition, because the plastic inlet tube can be injection molded along with the tray insert, and can thus be an integral component of the tray insert, implementation problems associated with shaped or angled metal inlet tubes, which are crimped to the filter as a separate component, are alleviated. In addition, because the plastic tray insert can be used with metal and composite filters, a convenient alternative is provided for implementing shaped or angled inlet tubes without requiring the use of an all-plastic filter. An example of a filter incorporating a tray insert having an integral exemplary angled plastic inlet tube in accordance with the present invention is illustrated in FIG. 13.

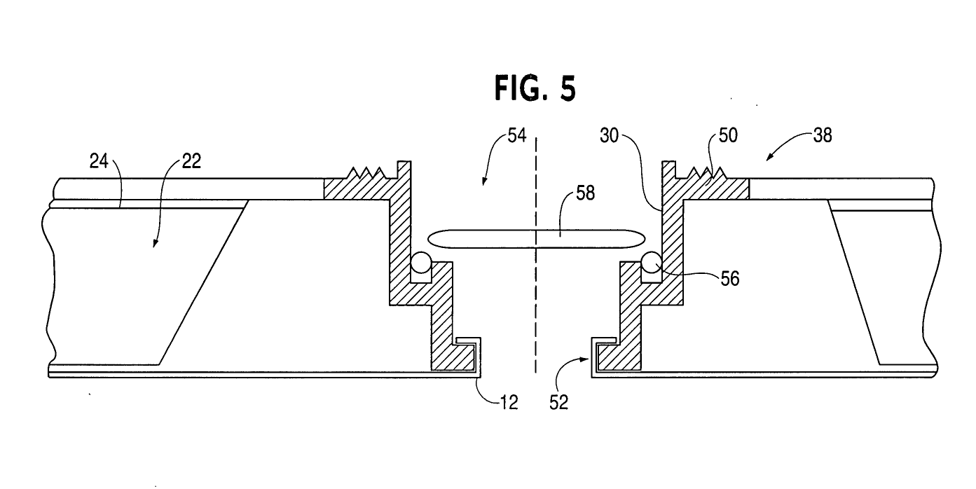

Another advantage of a plastic tray insert as compared to stamped metal ribs, is that the plastic tray insert can include a plastic inlet opening (including alternatively a plastic inlet tube), which can accommodate an anti-drainback device. Such devices can prevent or alleviate fluid from flowing out of the filter when fluid is not being drawn into the filter. An example of a plastic inlet opening incorporating an anti-drainback device suitable for use with plastic tray inserts according to the present invention is illustrated in FIG. 5.

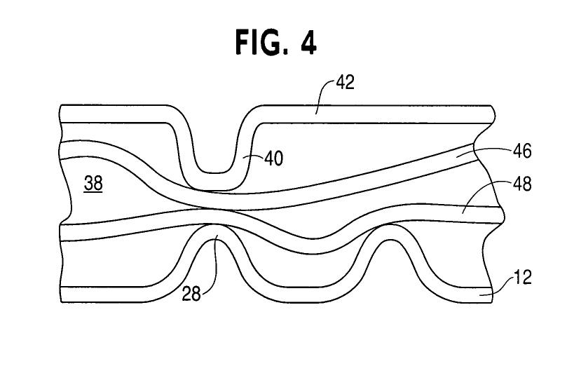

A plastic tray insert can also accommodate “pass-through” pinch points. A “pinch point” is a location in the filter, where the upper cover and lower cover are designed to engage one another in the interior (as opposed to edges) of the housing. For example, the top surface of a rib or projection which is stamped or molded in the lower cover engages the bottom surface of a rib or projection which is stamped or molded in the upper cover. The purpose of the pinch point is to provide structural support to the housing to prevent or alleviate deformations in the housing which may be caused when the filter is subjected to a vacuum. However, in prior art designs using at least one stamped metal cover, the filter bag is compressed at each such pinch point because the top and bottom of the filter bag are sandwiched between the top and bottom rib (i.e. the top of the bag is pushed against the bottom of the bag such that the bag is not held open at the pinch point), resulting in a loss of fluid flow area. A prior-art pinch point is illustrated in FIG. 4.

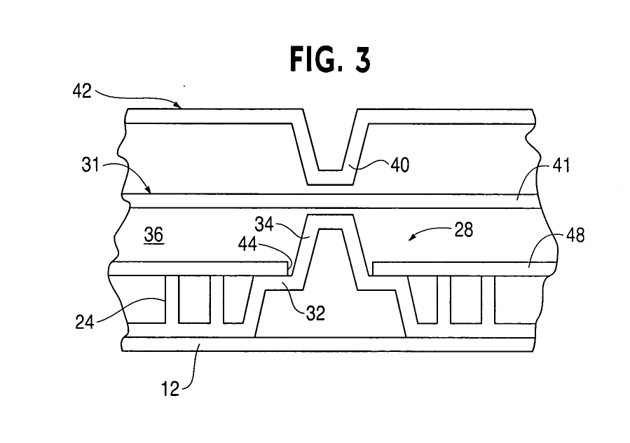

According to some embodiments of the present invention, the plastic rib tray insert includes plastic “pass-through” pinch points, which are capable of holding the filter media open at the pinch point while simultaneously providing structural support. For example, the filter bag can be designed to have a hole through which a plastic pinch point can protrude. Accordingly, the filter media is held open rather than compressed because only the top layer of the media is compressed at the pinch point. Specifically, the top layer of the filter media is sandwiched between the top of the plastic pinch point on the rib tray and the bottom of a rib or protrusion on the upper cover, while the bottom layer of the filter media rests the bottom of the plastic pinch point. To alleviate or prevent loss of fluid, the lower layer of the filter media can be sealed to the bottom of the plastic pinch point, by for example ultrasonic welding. An example of a pass-through pinch point suitable for use with plastic tray inserts according to the present invention is illustrated in FIG. 3.

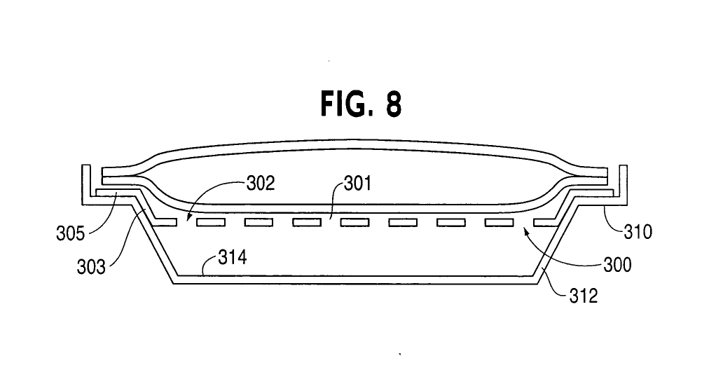

According to some embodiments of the invention, rather than resting on the bottom of the lower cover, the tray insert is suspended above the bottom of the lower cover and may be formed, for example, from plastic or metal. To suspend the tray insert, for example, the tray insert may have a bottom portion which includes vents to permit fluid flow and a lip portion spaced apart from the bottom portion by sides extending upward from the bottom portion. The lip portion of the tray insert is configured to rest on the lip portion of the lower cover, suspending the bottom portion of the tray insert above the bottom portion of the lower cover. In such embodiments, there is little or no lost clean flow area because there are no ribs integral with or adjacent the bottom of the lower cover to interfere with clean fluid flow. FIGS. 8-10 illustrate exemplary tray inserts in accordance with this embodiment of the present invention.

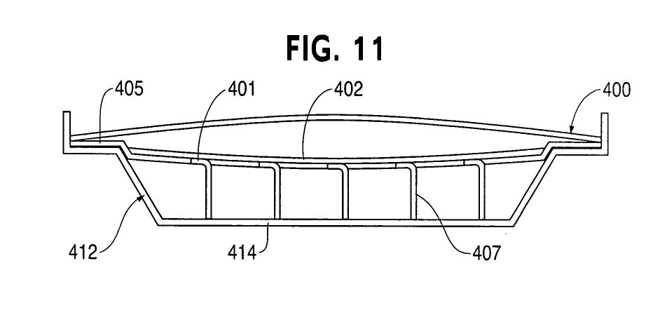

In some embodiments, the suspended tray insert may also include legs which extend downward from the tray insert toward the bottom of the lower cover. Such legs can be made relatively thin as compared to the stamped metal ribs and accordingly, even where the legs may touch the bottom of the housing, they may affect fluid flow to a lesser degree than the stamped metal ribs. For example, the legs may be the same thickness as the bottom of the tray insert, which is considerably thinner than the base of ribs which are stamped in the bottom of metal covers. FIG. 11 illustrates an exemplary tray insert in accordance with this embodiment of the present invention. Although the legs may rest on the bottom of the filter housing and may provide a support function with regard to the tray insert and lower cover, such embodiments are still referred to as “suspended try inserts.”

An embodiment of the present inventive apparatus is illustrated in FIG. 1. The tray insert 10 is shown resting on the bottom portion 14 of the filter housing lower cover 12. In addition to the bottom portion 14, the lower cover 12 also includes a side portion 16 extending upward from the bottom portion 14, and a lip portion 18 extending outward from the side portion 16 and which lip portion 18 is substantially parallel with the bottom portion 14.

The tray insert 10 includes a filter media supporting surface 20, ribs 22 extending below the supporting surface 20 to the bottom portion 14 of the lower cover 12, pass-through pinch points 28, and an inlet opening 30.

The supporting surface 20 is formed from first linear segments 24 substantially oriented in the direction of fluid flow interconnected by second linear segments 26 substantially oriented perpendicular to the direction of fluid flow. Attached to the underside of the first linear segments 24 are the ribs 22 which offest the supporting surface 20 above the bottom portion 14 of the lower cover 12. Embodiments including ribs are sometimes referred to herein as “rib-tray inserts.”

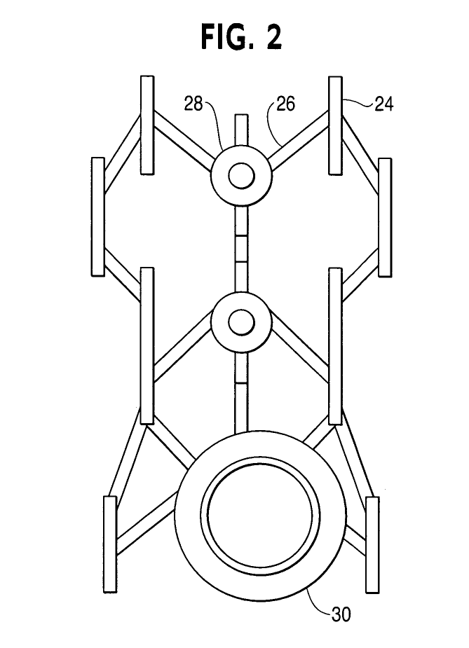

The tray insert dimensions preferably correspond to the length and width of the filter media (often in bag configuration). (The filter bag can be formed from filter media material having a length and width. The filter media material is folded in half along its length to form the filter bag. Thus the length of the filter bag is approximately half the length of the filter media material from which it is formed, and the width of the filter bag is approximately the same as the width of the filter media material from which it is formed.) Although FIG. 1 illustrates first linear segments 24 that extend predominately the length of the filter bag (including where interrupted by inlet opening 30 and/or pass-through pinch points 28) and second linear segments 26 that extend predominately the width of the filter bag (including where interrupted by inlet opening 30 and/or pass-through pinch points 28), the tray insert 10 can be formed from linear segments with smaller dimensions or larger dimensions. For example, FIG. 2 illustrates an embodiment wherein the overall dimensions of the tray insert 10 are approximately equal to the length and width of the filter bag, but wherein each of the first linear segments 24 are shorter than the length of the filter bag and each of the second linear segments 26 are shorter than the width of the filter bag.

Generally, the length, number, distribution, and width of first linear segments 24 is chosen to be sufficient to provide a filter media supporting surface 20 that keeps the filter media spaced apart from the bottom portion 14 of the cover 12, while minimizing impact on fluid flow. For example, for stiff filter media, fewer first linear segments 24 are needed for support. The orientation of the first linear segments 24 is preferably in the direction of fluid flow, and the width of first linear segments 24 is preferably as narrow as possible, to alleviate any negative impact on fluid flow.

Generally, it is preferred to minimize the number of second linear segments 26 because second linear segments 26 can have a greater impact on fluid flow than the first linear segments 24 as they are not oriented in the direction of fluid flow. Preferably, the number, length, and orientation of second linear segments 26 are chosen to be sufficient to connect the first linear segments 24, providing structural support and integrity to the tray insert 10, but also minimize impact on fluid flow. As with the first linear segments 24, the second linear segments 26 are preferably made as narrow as possible.

The tray insert additionally includes plastic pinch points 28 and an inlet opening 30. As shown in FIGS. 1 and 3, the plastic pinch points 28 includes a lip portion 32 that is substantially in the same plane as the first linear segments 24 and thereby forms part of the filter media supporting surface 20. The pinch point 28 also includes a protruding portion 34 which can pass through the filter media into the interior 36 of the filter bag 38. Preferably the protruding portion 34 has sufficient length to either engage a corresponding pinch point 40 stamped or molded in the upper cover 42. When the oil filter is assembled, the filter media 38 includes an opening 44 into which the protruding portion 34 protrudes. The filter media 38 material around the opening is preferably sealed to the lip portion 32 to avoid or alleviate fluid within the filter bag from leaking out through the opening rather than passing through the filter media material. This sealing can be accomplished, for example, by ultrasonic welding the filter bag 38 material to the lip portion 32 of the pass-through pinch point.

As best shown in FIG. 3, this “pass-through” pinch point configuration allows the pinch point 28 to provide structural support to the housing, while at the same time holding the filter bag 38 open, alleviating fluid flow problems of prior art designs using stamped metal ribs. That is, the pinch point 28 compresses only the upper part 41 of the filter bag 38 against the corresponding pinch point 40 in the upper cover 42, keeping the lower part 48 of the filter bag spaced apart from the upper part 46 off the filter bag 38. In contrast, in prior art designs, as illustrated in FIG. 4, both the lower part of the filter bag and the upper part of the filter bag are compressed between the lower cover metal rib and the corresponding pinch point in the upper cover.

The inlet opening 30, as illustrated in FIG. 1, can be simply a lip portion 50 which forms part of the filter bag supporting surface 20 and provides a surface to which the filter bag may be attached. For example, the filter bag may be ultrasonically welded to the tray insert inlet opening 50. The lower metal cover also includes an inlet opening 52, which can be used to align the filter tray and attach the filter tray to the lower metal cover. For example, the lower metal cover inlet opening 52 can be crimped to the plastic tray insert inlet opening 50. Accordingly, the filter bag need not be ultrasonically welded to the plastic tray insert inlet opening 50, but may be held in place by the crimped metal inlet opening 52.

In some embodiments, the inlet opening 30 is as shown in FIG. 5, and incorporates an anti-drainback device 54. In this example, the anti-drainback device is formed from an 0-ring 56 positioned within the inlet opening 30 and a stopper 58, which can, for example, be a metal or steel ball or plate. When fluid is drawn into the filter, the stopper is pushed upward and allows fluid into the filter. When fluid is no longer drawn into the filter, the stopper drops (possibly aided by a spring) and prevents or reduces fluid flow out of the filter.

FIG. 6 illustrates another embodiment of a tray insert 100 in accordance with the present invention. The tray insert 100 includes a filter media supporting surface 102 formed by ribs 104,, cross-bar segments 108, and an inlet opening 110. The ribs 104 and linear segments 106 are generally oriented in the direction of fluid flow. The cross-bar segments, which connect parallel lengths of interlinked rib segments 109, are therefore not oriented in the direction of fluid flow. In the illustrated embodiment, the cross-bar segments 108 are oriented substantially perpendicular to fluid flow.

As is shown, the bottom portion 116 of the lower metal cover 112 is preferably stamped with channels 114 which receive the cross-bar segments 108. The depth of the channels 114 preferably correspond to the height of the cross-bar segments 108 so that when the cross-bar segments 108 are fitted into the channels 114, the top face of the cross-bar segments 108 lie in a plane substantially the same as the bottom portion 116 of the lower metal cover 112.

The ribs 104 divide the fluid traveling along the lower cover (toward the outlet) into channels. If one channel has a relatively high flow rate, gaps are provided in the ribs and to allow fluid to “spill over” into the adjacent channel. The gaps cut out of the top 124 of the rib 104 also reduce the amount of media contact area at the top surface 124 of the rib 104 allowing a higher percentage of the media to be utilized.

As with the embodiment illustrated in FIG. 6, the length and width of the tray insert 100 substantially matches the length and width of the filter bag (not illustrated in FIG. 1). And, although in the illustrated embodiment, the ribs 104 are each substantially the length of the filter bag (including where interrupted by the inlet opening 110 and/or optional pinch points) and the cross-bar segments 108 are each substantially the width of the filter bag (including where interrupted by the inlet opening 110 and/or optional pinch points), the tray insert 100 can be formed from ribs 104 and cross-bar segments 108 with smaller dimensions or larger dimensions. For example, although the overall dimensions of the tray insert 100 can be approximately equal to the length and width of the filter bag, each rib 104 may be shorter than the length of the filter bag and each of the cross-bar segments 108 may be shorter than the width of the filter bag.

Generally, the length, number, distribution, and width of interlinked ribs 104 is chosen to be sufficient to provide a filter media supporting surface 102 that keeps the filter media spaced apart from the bottom portion 116 of the lower cover 114, while minimizing impact on fluid flow. For example, for stiff filter media, fewer ribs 104 are needed for support. The orientation of the ribs 104 are preferably in the direction of fluid flow, and the width of interlinked ribs 104 are preferably as narrow as possible, to alleviate any negative impact on fluid flow.

Generally, it is preferred to minimize the number of cross-bar segments 108 because the cross-bar segments 108, as in the embodiment of FIG. 6, require corresponding depressions on the lower cover that could interfere with fluid flowing into the filter inlet. Preferably, the number, length, and orientation of cross-bar segments 108 is chosen to be sufficient to connect the interlinked rib segments, providing structural support and integrity to the tray insert 100, but also minimize impact on fluid flow. As with the interlinked rib segments 109, the cross-bar segments 108 are preferably made as narrow as possible.

The inlet opening 110, as in the embodiment of FIG. 6, can be simply a lip portion 50 which forms part of the filter media supporting surface 20 and provides a surface to which the filter media may be attached. Or else, as with any plastic tray insert according to the present invention, the inlet opening can be configured to include an anti-drainback device as shown, for example, in FIG. 5.

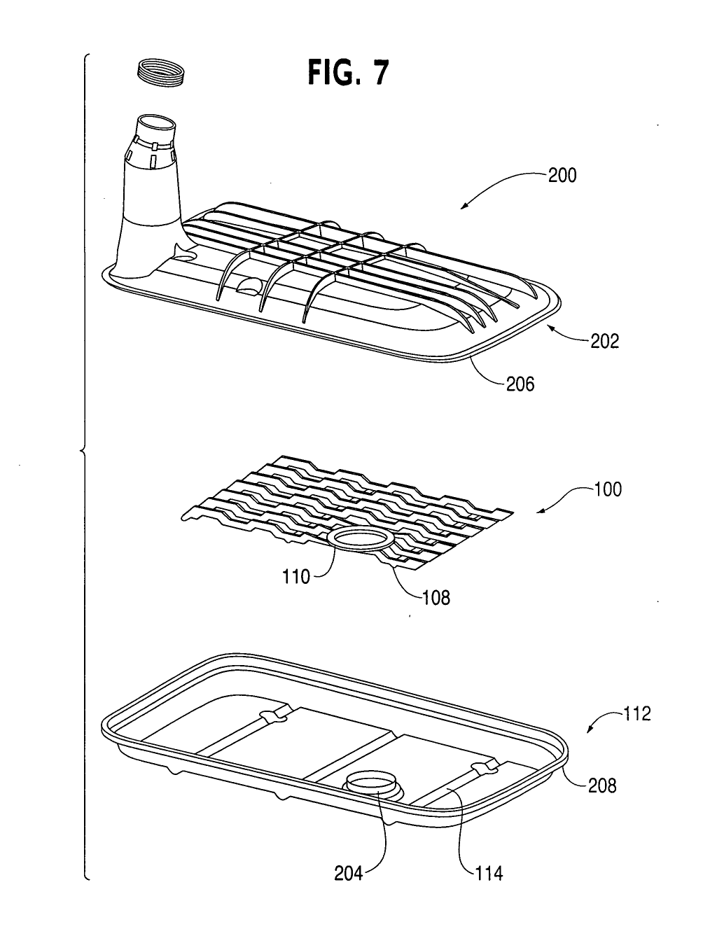

FIG. 7 is an exploded view of an oil filter 200 according to the embodiment of FIG. 6. The purpose of the figure is to illustrate one way in which an oil filter according to the present invention may be assembled. The oil filter 200 includes lower metal cover 112, tray insert 100, upper plastic cover 202, and a media in a bag configuration (not shown). The tray insert 100 includes ribs 104, cross-bars 108, and inlet opening 110. The lower metal cover 112 includes channels 114 for receiving the cross-bar segments 108 and an inlet opening 204.

To assemble the oil filter 200, a filter bag, which includes an opening to coincide with inlet opening 110, is positioned on the tray insert 100. The filter bag, tray insert 100 and lower metal tray 112 are arranged so that the inlet openings 110, 204 align with each other. The filter bag can be bonded to the tray insert at the location of the inlet opening 110. For example, filter media material surrounding the opening may be ultrasonically welded to the inlet opening 110. Alternatively, a portion of the lower metal cover inlet opening 204 is crimped over the tray insert inlet opening 110 and the portion of the filter media surrounding the opening to the filter bag, attaching the three components to one another. The crimped metal from the inlet opening 204 is thus found in the interior of the filter bag. The upper cover 202 is then placed over the lower metal cover so that the lip portion 206 of the upper cover 202 rests on the lip portion 208 of the lower metal cover 112 and the two covers 202, 112 are then crimped together.

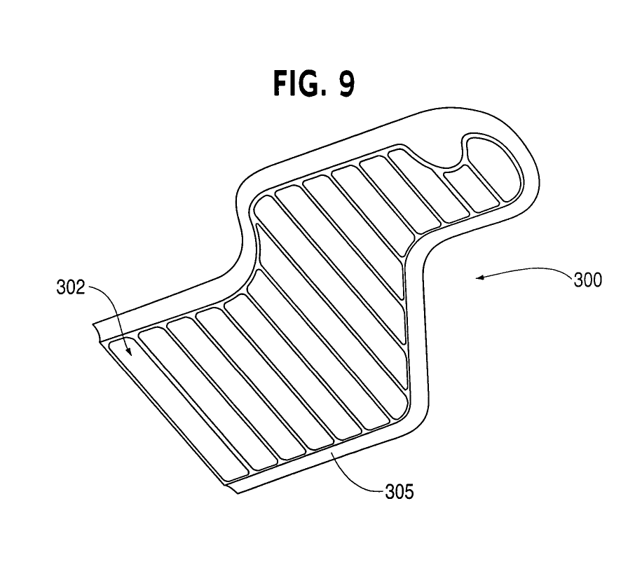

FIGS. 8 and 9 illustrate another embodiment in accordance to the present invention. As shown, the tray insert 300 is a substantially flat pan suspended above the bottom portion of the lower metal cover 312. The tray insert 300 includes a substantially flat pan portion 301, sides 303 projecting upward from the pan portion 301, and a lip portion 305. The lip portion 305 is configured to engage the lip portion 318 of the lower cover, thereby suspending the tray insert 300 above the bottom portion 314 of the lower cover 312.

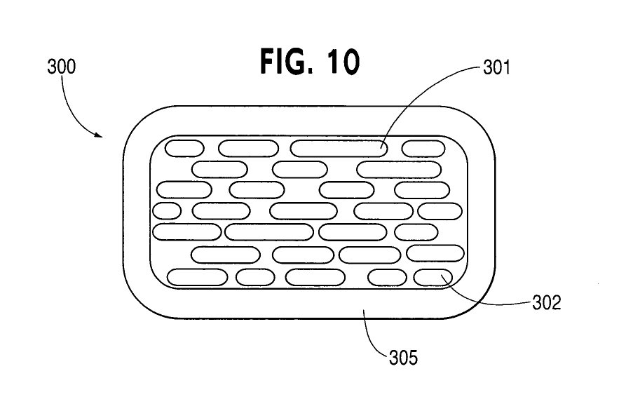

The pan can be, for example, plastic or metal material stamped with holes 302 (also referred to as “cut-out portions” or “vents”) to permit fluid flow. The number, distribution, size, and shape of the cut-out portions are sized to adequately support the media thereby minimizing deflection toward the lower cover (which would block clean fluid on its way to the filter outlet) without reducing the fluid flow through the media. The localized flow rate through the media in areas that are supported by a rib 20, 301 is greatly reduced. Consequently, supporting the media too much will result in a higher pressure differential across the media and, therefore, through the filter. Preferably the pan is designed so that the surface area occupied by the pan material, such as the metal or plastic from which the pan is formed, is minimized, to reduce areas of lost fluid flow. Accordingly, the amount of material is preferably only so much as is needed to provide structural support and maintain the filter bag off the bottom portion 314 of the lower cover 312. FIG. 9, for example, is a perspective view showing one possible pattern of vents for a suspended tray insert in accordance with the present invention. FIG. 10 is a top view of another suspended tray insert in according with the present invention and illustrates another exemplary pattern of vents suitable for use with suspended tray inserts according to the present invention.

FIG. 11 illustrates another embodiment of a suspended tray insert design 400 according to the present invention. The embodiment of FIG. 11 is a variation of that shown in FIGS. 8-10 and thus too can be plastic or metal and includes a lip portion 405 for suspending the pan portion 401 above the bottom portion 414 of the lower metal cover 412. Specifically, in the embodiment of FIG. 11, the tray includes supporting legs 407. The legs can be formed from the cut-out portions 402 and may rest on the bottom portion 414 of the lower metal cover 412 and thus may also support the pan portion 401 (or filter supporting surface) above the bottom portion 414 of the lower metal cover 412. For example, whereas in the embodiment shown in FIGS. 8 and 9, the cut-out portion is completely removed and thrown away, in the illustrated embodiment, the cut-out portion is a tab which is bent downward forming both a hole (where the cut-out material was removed) and a leg integrally attached to the pan. Of course, the leg need not be integral and may be separately made and attached to the pan. Enough legs 407 are created to sufficiently support the lower cover 414 from bowing upward and the pan portion from deflecting downward during filter operation. Not every cut-out portion 401 must have a supporting leg 401. Thus, for example, even where the legs are formed as tabs, by leaving a section of the cut-out portion attached to the pan and bending the cut-out portion downward, the tray insert may include a mixture of cut-out portions which are completely cut-away to form only holes and cut-out portions which are tabs forming both holes and legs.

As with the illustrated plastic rib-tray insert embodiments, when the embodiments of FIGS. 8-10 are made of plastic, they can include plastic pinch-points and plastic inlets, for example, as described above.

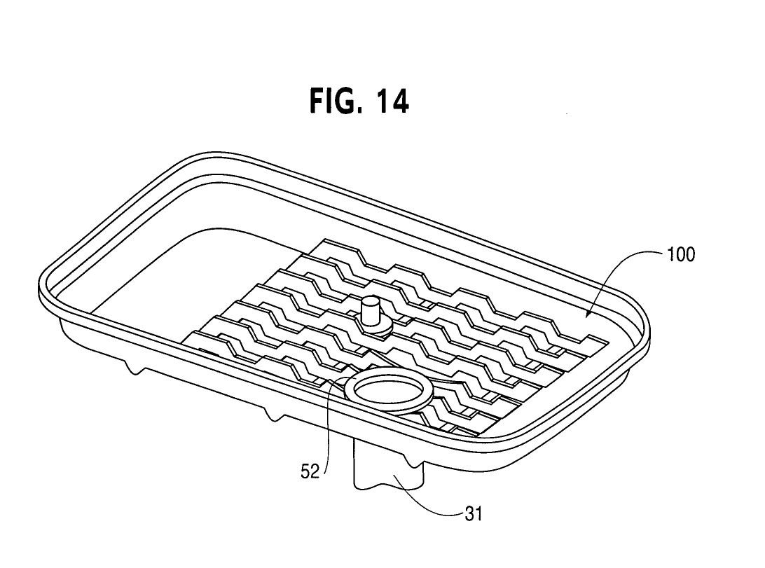

Plastic tray inserts in accordance with the present invention can include plastic inlet tubes 31, as shown in FIGS. 13 and 14, which are preferably integrally formed with the inlet opening 30. When used in connection with a plastic rib-tray insert 100, also as shown in FIG. 13, the rib tray insert 100 and its integral inlet tube 31 are assembled into the metal lower cover 500 by press fitting the rib tray insert 100 into the metal lower cover inlet form (hole) 52. The metal lower cover inlet form 52 can also be formed after the press fit to embed the metal into the plastic tube for additional strength. The filter media can be sonically welded to the rib tray insert at the inlet in this implementation. Further, an o-ring (not shown) can optionally be added at the inlet/lower cover interface to improve sealing.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. An insert for an engine or transmission filter, comprising:
a plastic tray adapted to support filter media above a bottom portion of a filter housing, said plastic tray comprising first segments having ribs and second segments interconnecting the first segments.

2. An insert according to claim 1, wherein said first segments are oriented substantially parallel with respect to each other.

3. An insert according to claim 2, wherein the second segments are oriented substantially perpendicular to said first plastic segments.

4. An insert according to claim 1, wherein said plastic tray has a width substantially corresponding to the width of a filter media and a length substantially corresponding to the length of the filter media.

5. An insert according to claim 4, wherein at least one of said first segments has a length corresponding to the length of the filter media.

6. An insert according to claim 5, wherein at least one of said second segments has a length corresponding to the width of the filter media.

7. An insert according to claim 2, wherein said first segments have a length-wise cross-sectional profile, the length-wise cross-sectional profile being a substantially planar top surface and ribs extending downward from said top surface.

8. An insert according to claim 2, wherein said first plastic segments comprise rib portions interconnected by linear segments, said ribs having cutouts to permit fluid flow across channels and to facilitate media usuage/utilization.

9. An insert according to claim 8, wherein each of said linear segments lie in substantially the same plane and said rib portions project upwardly from said linear segments.

10. An insert according to claim 9, wherein said rib portions include a substantially flat surface parallel to and spaced apart from said linear segments, wherein said flat parallel surface forms at least a portion of a filter media supporting surface.

11. An insert according to claim 10, wherein said second segments are connected to, and located below, said linear segments.

12. An insert according to claim 2, wherein said plastic tray is injection molded.

13. An insert according to claim 1, wherein said first segments and second segments are integral with one another such that said plastic tray is a unitary plastic piece.

14. An insert according to claim 1, further comprising at least one pass-through pinch point.

15. An insert according to claim 1, wherein said plastic tray further comprises an inlet opening adapted to accommodate an anti-drainback device.

16. An insert according to claim 1, wherein said plastic tray further comprises a plastic inlet tube.

17. An insert according to claim 13, wherein said plastic tray further comprises a plastic inlet opening.

18. An insert according to claim 15, wherein said plastic inlet opening is adapted to accommodate an anti-drainback device.

19. An engine or transmission filter, comprising:
a filter housing comprising a lower cover and an upper cover;
filter media positioned within said filter housing; and,
a plastic tray adapted to support said filter media above a bottom portion of said lower housing section, wherein said plastic tray comprises first segments having ribs and second segments interconnecting the first segments.

20. A filter according to claim 19, wherein said plastic tray rests on a bottom portion of said lower housing section.

21. A filter according to claim 20, wherein said ribs rest on the bottom portion of said lower housing section.

22. A filter according to claim 20, wherein said second segments rest on the bottom portion of said lower housing section.

23. A filter according to claim 20, wherein the bottom portion of said lower housing section includes channels configured to receive said second segments.

24. A filter according to claim 23, wherein said channels have a depth, and said second segments have a height, and the depth of said channels is approximately equal to the height of said second segments.

25. A filter according to claim 19, wherein said plastic tray further comprises an integral plastic inlet tube.

26. A filter according to claim 19, wherein said filter further comprises an anti-drainback device and said plastic tray further comprises an inlet opening adapted to cooperate with said anti-drainback device.

27. A filter according to claim 19, wherein said plastic filter tray further comprises at least one integral pass-through pinch point, and said filter bag has an interior, and said least one said pinch point protrudes into the interior of the filter media.

28. A filter according to claim 27, wherein at least one said pinch point has a lip and the filter bag is ultrasonically welded to the lip of the at least one pinch point.

29. A method of making an engine or transmission oil filter, comprising:
injection molding a plastic rib tray insert comprising first segments having ribs and second segments interconnecting the first segments.

30. A plastic tray insert for an engine or transmission filter, comprising:
means for supporting filter media away from the filter housing, wherein said means comprises a plastic material and is a separate component from the housing.
